(19) United States
(12) Patent Application Publication
(10) Pub. No.: US 2005/0075969 A1
(43) Pub. Date: Apr. 7, 2005

(54) Third-party payday advance loan method and system operated directly with and through employers

(75) Inventors: David F. Nielson, Draper, UT (US); Jarrod E. Clarke, Draper, UT (US)

Correspondence Address: CHAPMAN AND CUTLER, 111 WEST MONROE STREET, CHICAGO, IL, 60603, US

(73) Assignee: Prime Acceptance Corp., Salt Lake City, UT (US)

(21) Appl. No.: 10/677,883

(22) Filed: Oct. 2, 2003

(51) Int. Cl. G06F 17/60

(52) U.S. Cl. 705/38

(57) ABSTRACT

A method and system for a loan-making entity to provide a benefit to employees of others by way of payday advance loans on demand to qualified borrowers. Agreements are entered into between the entity and the employee and between the entity and the employer. When an employee needs a payday advance loan, he or she telephones or goes on-line to the entity and asks for a desired amount. Employment status but no other credit information is checked, and the funds are immediately available to the employee, in cash, by check, by debit card funding, or the like. The entity advises the employer electronically of all outstanding loans on or before the next payday, and loans with fee amounts are deducted from employees' paychecks and the loans and fees are paid to the entity. Any shortfalls in monies payable roll over to the next pay period, with added fees as appropriate. The entity may collect only against the employee, not the employer, under the agreements, if there is a default.

### 1. FIELD OF THE INVENTION

The present invention relates to business methods for making and recouping personal loans, particularly those commonly known as payday advance loans, whereby employed persons can receive monies a few days in advance of their usual payment dates for emergencies and unusual needs.

### 2. BACKGROUND OF THE ART

Sometimes employees will approach their employers directly, particularly in small business situations, for paycheck advances as individual favors. These approaches are fraught with embarrassment for the employee, including uncomfortable explanations for the employer or executive receiving the plea, and even uncomfortable explanations or refusals by the employer if available cash is tight or some other problem is perceived. If a loan is made, then the employer must keep track of what monies were advanced and to whom, and also remember to recoup the loan at the next payday. Fees or interest charges are rarely made, so the loan is a bother and a complete loss to the employer. FIG. 5 shows a typical employer-managed pay advance system, as is already known.

Commercial payday advance loans have typically been made by currency exchanges and small-loan entities directly with persons expecting to receive payments in the near future, particularly pay checks from employment, either salaried or hourly. These loans are occasionally criticized as “predatory loans” due to the fees and high effective interest rates often charged. Relationships are made solely between the borrower and the lender, although the lender typically will check the person's credit history and may deny a loan based on facts found there. FIG. 6 shows a typical separate agency pay advance system as is already known.

Tax refund anticipation loans have long been allowed by the federal government under controlled conditions of tax return preparation and refund entitlement proofs, with money lent by a third party (as in FIG. 6 above). However these checks come just once a year and so are unlike payday advance loans, in view of the latters' more frequent use and availability.

### SUMMARY OF THE INVENTION

A payday advance loan method and system is created by an entity's entering into contracts among itself, as a money-lending entity, an employer, and any of the employed individuals working for that employer who may want or need short-term loans of cash against coming paychecks. The entity provides the contract forms, software for the employer's computer implementation and management of its part of the method and system, and an agreement for making loan advance funds available to the employees, all as an employment benefit to the employees. The contracts provide for repayment of the loans and associated fees from an employee's next net paycheck, and for rolling over any shortfall (as due to vacation or lesser hours) as a new loan with a further fee. The contract with the employer may provide that the entity bears all risk of loss of defaulted loans where required recent work history checks on an employee prior to approving a loan were done properly.

An object of the invention is to provide a simple, direct benefit to employees of participating employers that is made easy to administer for both the employer and the loaning entity, does not draw down cash or paycheck funds of the employer prior to regularly scheduled paydays, and provides maximum security to the loaning entity.

### BRIEF DESCRIPTION OF THE DRAWINGS

FIG. 1 is a relational block diagram showing the contractual relationships established among the loaning entity, the employer, and the employee in advance of making any payday advance loan.

FIG. 2 is a flowchart and decision tree showing the procedure for considering and rejecting or approving and making a payday advance loan once a participating employee requests one.

FIG. 3 is a flowchart and decision tree showing the procedure for repaying payday advance loans to the loaning entity through the employer, using funds deducted from employees' paychecks, aggregated from all participating employees with loans during the pay period.

FIG. 4 is a flowchart showing the detailed steps involved in requesting, approving, making, and then repaying a sample, representative employee's payday advance loan, including potentials for shortfalls and renewals or collection activities.

FIG. 5 is a flowchart depiction of a prior art employer to employee pay advance loan method and system.

FIG. 6 is a flowchart depiction of a prior art loan agency to employee pay advance loan method and system.

### THE PREFERRED EMBODIMENTS

Quite often employees of companies have a need for extra money for various reasons. There may be some emergency, a bill to pay, a purchase or repair to make, or just a need for extra cash for a weekend getaway.

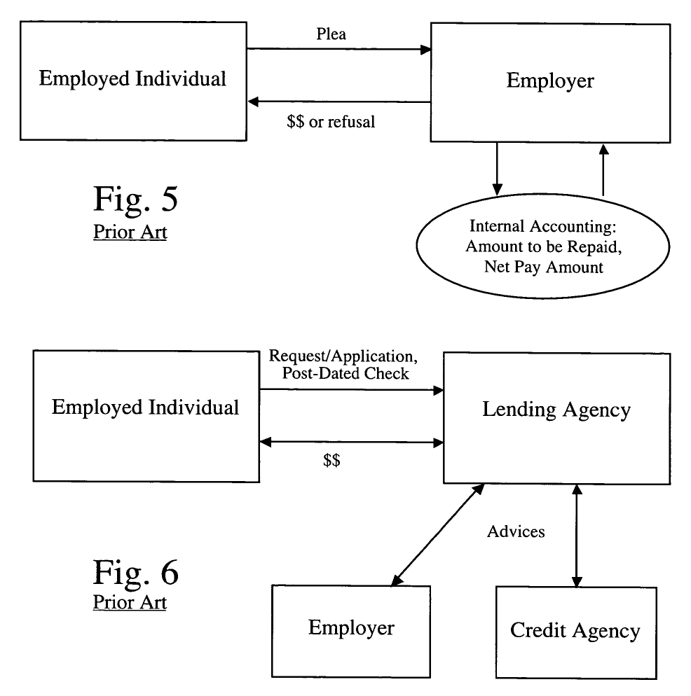

For an employee, a most difficult and uncomfortable part of filling this need, in one method known in the art (see FIG. 5), is going to an owner or executive of his or her employer and asking for an advance of money to be paid. This is embarrassing in any event and can lead to a deterioration of the relationship between the employer and employee.

An employer in most cases does not like to give advances for several reasons. The employer must use its own cash or capital for the loan, write and maintain its own contract with the employee, take the risk of giving the loan and perhaps having the employee quit, and keep track of who took advances during the pay period. The employer must then be sure to deduct the amount accurately from the proper paychecks. This can be a huge burden for an employer, and most do not want to deal with it; many employers simply refuse such requests.

Another form of payday advance loans involves a regular commercial lender which makes small loans under state or local financial law (see FIG. 6). A popular form of loan, people are invited to take loans against any sort of reasonably certain future income or expectancy in return for a high interest rate and fees until paid. Sometimes a post-dated check is taken as collateral, dated to the time a future deposit to the account is to be made. A credit history or reference check may be taken, at considerable expense to the borrower, and employment status may also be checked. The borrower is responsible for repaying the loan, in person, by a post-dated check, automatic bank debit method, or the like, and the lender has recourse only to the borrower, individually.

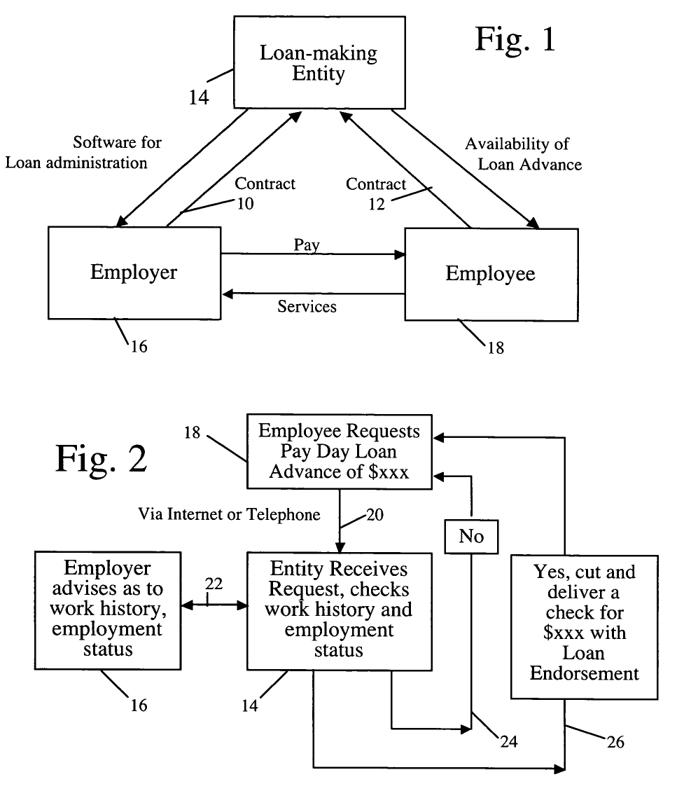

The present invention involves entering into simple contracts 10 and 12 among a loan-making entity 14, an employer 16 of individuals 18 who may need payday advance loans, and each or any of those individual employees 18. As shown in FIG. 1, the entity-employer contract relation 10 provides that if an employee 18 takes out an advance with the entity 14, the employer 16 will deduct the advance amount and related fees from the next paycheck for the employee 18 on behalf of the entity 14. The employer 16 agrees then to then write one check (or make an electronic transfer), representing all amounts advanced plus the related fees, to the entity. Software for the employer's communicating and interacting on-line with the entity is provided to the employer upon the signing of the contract 10.

The employee 18 will also sign a contract 12 with the entity, as in FIG. 1, agreeing that he or she will allow the employer 16 to deduct whatever was borrowed plus a fee out of his or her next paycheck. Once both contracts 10 and 12 are signed, they will be submitted and entered into the entity's web site database. Each participating employee 18 will receive a loan limit based on his or her time employed and current income; this limit will vary from time to time. No other credit check is generally performed. Participating employees 18 receive a card from the entity 14 showing their account information.

If and when an employee 18 needs a pay advance, he or she may do so in either of two ways, as in FIG. 2 at 20. The employee 18 can log-on to the web site of the entity 14 with his or her name and password and indicate, as by clicking a box, the amount of money needed. Or, the employee 18 can make a phone call to a number on the card and talk live to a customer representative at the entity 14. A quick check is made as at 22 of the employee's status at the employer 16. If there is a problem, the employee is promptly notified as a 24 that the loan will not be made, or not made in the amount requested. If all is in order, then money is made available immediately in cash at the entity's office during normal business hours, or the money can be sent by check as at 26 within 1 business day to the borrower's place of business. The check may have an endorsement notice in legally binding forms constituting a further loan note, and also a payroll deduction authorization, when signed or deposited into an account. Other means, as issuance of a debit card upon account opening and funding for each loan, may similarly be used to place cash in the hands of the employee 18.

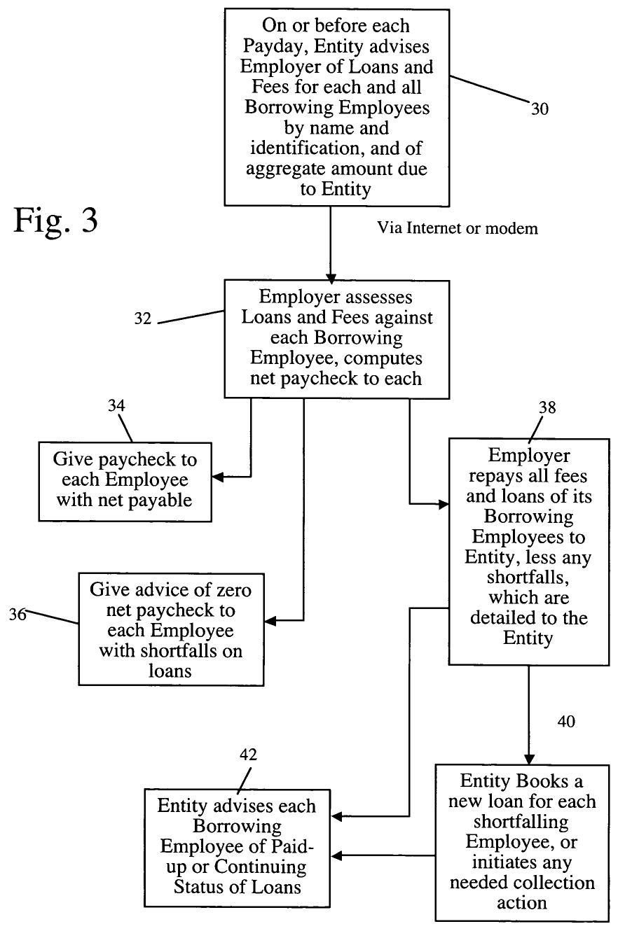

FIG. 3 shows the steps taken when payroll is to be processed by the employer 16, and employees 18 have outstanding loans from the entity 14. The entity 14 will advise the employer 16 that one or more of the employees there has a payday advance loan outstanding. A payroll clerk of the employer 16 then will log on to the entity's web site with the employer's name and password. A list of all the loans outstanding from employees 18 of the employer 16 from the entity 14 will then appear, with either employee names and loan amounts or just identifying numerical information for the employee(s) 18, as the entity 14 and employer 16 desire and have agreed. The clerk of the employer 16 will note or make any modifications necessary to the list, as for employees 18 who have left unexpectedly before payday or who have insufficient pay coming to fully repay their loans, and then will click on a “process payroll” button. Payroll checks are cut for each employee 18 with net pay coming, as at 34. Employees 18 who have loans larger than their checks will receive advices of same by way of a pay stub in a nominal amount with indications of all deductions including the payday advance loan payment made for the employee. Processing the payroll of the employer 16 also will cause the system at the entity 14 to total all the loans and fees after noting any exceptions, and give instructions on where the employer is to send its check or transfer its funds for repayment of all the loans outstanding to the extent possible, as at 38. In most cases, the added interaction with the entity 14 and added steps in processing the payroll with the loans properly deducted is just a 5 minute process for one payroll clerk, done just once for each weekly or bi-weekly pay period.

Where there is a shortfall between a loan and fee amount due from an employee 18, the entity 14 will book a new loan for that employee if appropriate or will initiate collection action against the employee if appropriate, as at 40 in FIG. 3. In any event the entity will communicate with each employee 18 as to the status of the payday advance loan, whether it is paid up or has some amount rolled over, as at 42.

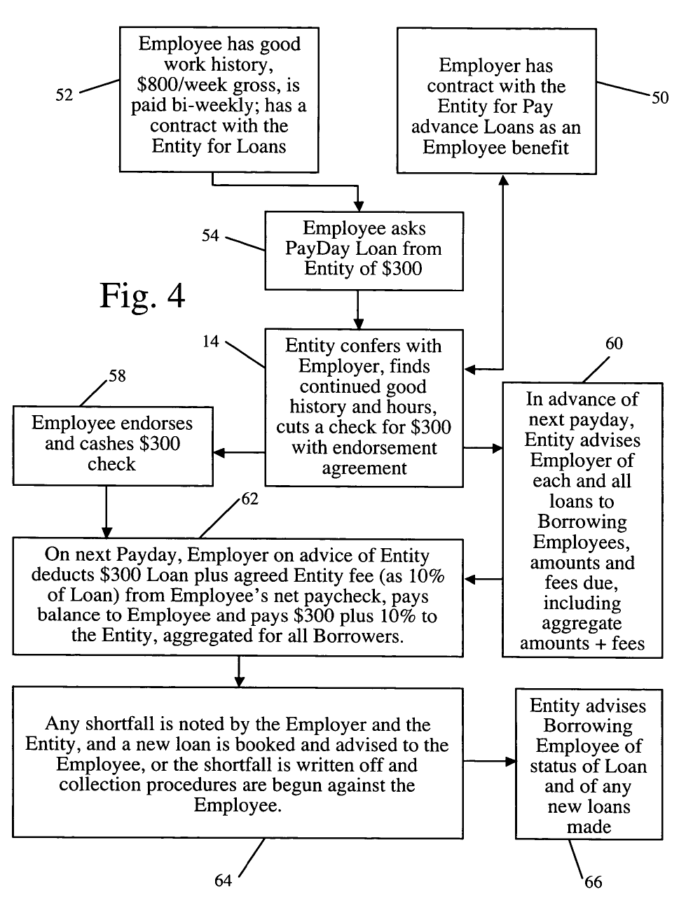

As an example of the application of the method and system of this invention, FIG. 4 shows the process from start to finish for a given loan, after the arrangements of FIG. 1 have been made among the entity 14, an employer 50, and an employee 52 of that employer. The participating employee 52 is in good standing in his company and has a good work history, making about $800 per week; he is paid bi-weekly. Upon realizing a need for a $300 payday advance loan 9 days before the next payday, the employee 50 contacts the entity 14—by telephone or by Internet—and asks for a loan of that amount, at 54. The entity 14 confers electronically with the employer 50 and confirms the continued satisfactory employment status of the employee 52, as at 56, and promptly cuts and delivers a check to the employee for the $300 advance. The check contains an endorsement agreement constituting a loan agreement, and a payroll deduction authorization, effected when the employee 52 cashes the check, at 58.

As the next payday approaches for the employer 50 and employee 52, the entity 14 contacts the employer 50 to advise that a payday advance loan of the employee 52 is outstanding, as at 60, and amounts to, for instance, $330, including a 10% fee. This information is aggregated with all other loans of employees of that employer 50. The payroll clerk of the employer 50 uses the software provided by the entity 14 to check to see that employee 52 indeed has a pay check of at least $330 net coming to him from services provided, and deducts that $330 from the net pay as a line item deduction on the check stub, as at 62, paying it to the entity in aggregate for all borrowers. Any shortfall for employee 52 or another is noted by the employer 50 to the entity 14, as at 64. The entity 14 then will advise employee 52 of the repayment in full of the loan, or of the carrying of a portion of the loan to another pay period with a further fee as applicable, according to the original agreements, as at 66.

Many variations may be made in the method and system of the invention as shown and its manner of use, without departing from the principles of the invention as described herein and/or as claimed as our invention. Minor variations will not avoid the use of the invention.

1. A method for a loan-making entity to provide payday advance loans to selected, qualified individuals, the method comprising the steps:
forming a first contract between the entity and an employer of said individuals for a system of payday advance loans from the entity as a benefit for such individual employees thereof;
forming a second contract between the entity and each of said individuals who may desire and qualify for a payday advance loan either presently or in the future;
taking said qualified individuals' applications from time to time to the entity for payday advance loans and disbursing funds from the entity to each of said qualified individuals;
advising the employer of each said loan, on or in advance of a payday for the borrowing individual, of the amount of the loan and fees agreed for processing and making the loan;
facilitating the employer's deducting the amount of the loan and fees from the net amount of the paycheck of each individual and paying the balance to the individual on said payday; and
facilitating the employer's paying the amount of said loans and fees of the participating individual to the entity upon said payday.

2. The method of claim 1 wherein when a plurality of loans are outstanding to more than one individual employee of the employer and repayable on a given payday, arranging to aggregate the loans and fees payable to the entity from the employer's paycheck deductions and to pay the aggregate to the entity on said payday.

3. The method of claim 1 further comprising the step of having each individual endorse a paper check for the loan amount which bears a legend above the endorsement signature line that comprises a further contract for repayment of the loan and fees for the loan on the next payday and also a payroll deduction authorization.

4. The method of claim 1 wherein the first and the second contracts provide that if payable funds on the individual's next paycheck are insufficient to repay the loan and fees in full to the entity then at least a portion of the payable funds are paid to the entity and a new loan is created for the shortfall, payable with a further fee upon the next payday.

5. The method of claim 4 wherein the first contract provides that if an individual's employment relation with the employer is terminated before repayment of all loans and fees to the entity from net paychecks due, the entity accepts the loss subject to collection efforts by the entity against the individual, without liability of the employer.

6. The method of claim 1 wherein the payday advance loan monies are provided in cash by the entity to the individual in person.

7. The method of claim 1 wherein at least the arranging, advising, and facilitating steps are conducted over a global information computer network.

8. A system for administering, paying, and repaying payday advance loans, the system comprising:
a first contract between an employer and a money-lending entity, the contract providing for making payday advance loans to employees of the employer at minimal cost and risk to the employer and repayment of the loans and fees therefore by the employer from net earnings of each of the employees taking said loans;
a second contract between an employee of the employer and the entity, the second contract providing for the making of payday advance loans to the employee from the entity and authorizing payroll deductions for repaying the loan and paying the fees therefore and for rolling over any unpaid amounts into a new loan on each payday;
a payday advance request or application form;
a payday advance loan approval processor and loan disbursement system operated by the entity in cooperation with the employer;
a payday advance loan and fee accounting aggregator system operated by the entity in cooperation with the employer for tracking loans, net pay, and payment of loans and fees from the net pay; and
a loan repayment system for transferring funds on said payday to the entity in the amount of the loans and fees being paid and for accounting for said transfers to the entity, to each of the employees, and to the employer.
